(19) United States
(12) Patent Application Publication
(10) Pub. No.: US 2004/0045467 A1
(43) Pub. Date: Mar. 11, 2004

(54) FLEXOGRAPHIC PRINTING PAD, AND METHOD FOR WRAPPING PHOTOSENSITIVE PRINTING PLATE

(76) Inventor: Tsuneo Nakagaki, Aichi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/380,162

(22) PCT Filed: May 23, 2002
(86) PCT No.: PCT/JP02/04996

(30) Foreign Application Priority Data
May 28, 2001 (JP) 2001-159730

(51) Int. Cl. B41F 1/00

(52) U.S. Cl. 101/477

(57) ABSTRACT

A photosensitive printing plate having a thickness of about 3 mm can be readily used on a printing machine set for use with a photosensitive printing plate having a thickness of about 7 mm. There is provided a flexographic printing pad which facilitates combined use of a photosensitive printing plate having a thickness of about 7 mm and that having a thickness of about 3 mm, enables an improvement in ease of replacement of a photosensitive printing plate, and ensures a high printing characteristic. A base sheet 1 serving a flexographic printing pad has a magnet section 10, a cushion section 20, and a polyester film 30. The magnet section 10 and the cushion section 20 are arranged side by side in the same layer. One surface of the magnet section 10 and that of the cushion section 20 are bonded to the polyester film 30.

### FIELD OF THE INVENTION

The invention relates to flexographic printing material, and more particularly, to a flexographic printing pad which acts as base material when a printing plate made of photosensitive resin (i.e., a photosensitive printing plate) is wrapped around a printing cylinder of a rotary press.

### BACKGROUND

Flexographic printing (also called flexible printing) has hitherto been practiced in the field of letterpress printing, wherein areas that are not to be used for printing are receded with reference to areas that are to be used for printing. Flexographic printing primarily makes use of printing plates made of photosensitive resin (hereinafter called “photosensitive printing plates”), because such photosensitive printing plates have a merit of being able to be produced through inexpensive and simple manufacturing processes.

In order to achieve a superior printing characteristic on a material having a rough surface and corrugated mediums, such as a corrugated Board, which would cause unevenness in printing pressure, the thickness of a photosensitive printing plate for use in flexographic printing is usually set to 7 mm or thereabouts. Specifically, a photosensitive printing plate having a thickness of about 7 mm is used. Because of this, in reality, a gap between a printing cylinder and a pressure cylinder in a printing machine is set so as to cope with a photosensitive printing plate having a thickness of about 7 mm. For example, a gap between the printing cylinder and the pressure cylinder is set to a thickness determined from the thickness of a material to be printed in consideration of a thickness of 7 mm.

The diameter of the printing cylinder and that of the pressure cylinder are also set so as to become equal when a photosensitive printing plate of about 7 mm thick is wrapped around the printing cylinder. In a printing machine, a gear provided in alignment with the printing cylinder is meshed with a gear provided in alignment with the pressure cylinder, to thereby transmit rotational force of the printing cylinder to the pressure cylinder and rotate both the printing cylinder and the pressure cylinder. Smooth rotating actions are achieved by making the diameter of the printing cylinder plus the thickness of the photosensitive printing plate equal to that of the pressure cylinder. The diameter of the printing cylinder is smaller than that of the pressure cylinder by only an amount corresponding to the thickness of the photosensitive printing plate.

A photosensitive printing plate formed to a thickness of 3 mm or thereabouts; i.e., a photosensitive printing plate having a thickness of about 3 mm, is available in consideration of an improvement in ease of operation (particularly, ease of transport) achieved by weight reduction, prevention of breakage of a photosensitive printing plate, resource savings, and a reduction in the amount of industrial waste disposal. As mentioned above, the diameter of the printing cylinder and that of the pressure cylinder in the printing machine are set for a photosensitive printing plate having a thickness of about 7 mm. Therefore, a photosensitive printing plate having a thickness of about 3 mm cannot be used directly in such a printing machine. A cushion made of rubber material having a thickness of about 4 mm is fixedly wrapped around the printing cylinder with an adhesive, and the photosensitive printing plate having a thickness of about 3 mm is wrapped around the cushion.

The photosensitive printing plate is made of photosensitive resin, such as synthetic rubber, in the form of a plate. At present, the photosensitive printing plate is commonly produced through use of a solvent, such as chlorinated hydrocarbon solvents or petroleum solvents.

When the cushion is fixedly wrapped on the surface of the printing cylinder through use of an adhesive, the cushion cannot be readily removed. For this reason, the printing machine cannot be utilized for a photosensitive printing plate having a thickness of about 7 mm.

As mentioned above, chlorinated hydrocarbon solvents or petroleum solvents are currently used for developing a photosensitive printing plate. However, if in the future these solvents give way to aqueous solution, a necessity for making the printing machine compatible with a photosensitive printing plate having a thickness of about 3 mm would become more urgent. More specifically, proliferation of photosensitive printing plates involving usage of aqueous solution in the field of flexographic printing in response to regulations on chlorinated hydrocarbon solvents and petroleum solvents is conceivable. Inherent difficulty is encountered in imparting a thickness of 3 mm or greater to a photosensitive printing plate involving usage of aqueous solution. However, a photosensitive printing plate having a thickness of about 7 mm also exists. Hence, a necessity for making a printing machine compatible with a photosensitive printing plate having a thickness of about 7 mm in conjunction with that having a thickness of about 3 mm becomes more urgent.

Accordingly, the invention is aimed at providing a flexographic printing pad which facilitates use of a photosensitive printing plate having a thickness of about 3 mm in a printing machine set for use with a photosensitive printing plate having a thickness of about 7 mm and which also facilitates concurrent use in the printing machine of both the photosensitive printing plate having a thickness of about 3 mm and that having a thickness of about 7 mm.

### SUMMARY OF THE INVENTION

The invention has been conceived to solve the problem. First, the invention is characterized by providing a flexographic printing pad used as a member for raising a photosensitive printing plate during flexographic printing, the pad comprising a magnet section and a cushion section assuming a sheet-like shape.

In the first configuration, the magnet section is provided. Hence, when a printing sheet (also called a “printing plate”) having a photosensitive printing plate is wrapped around a cylinder, the printing sheet is wrapped over the flexographic printing pad while the magnet section is attached to the cylinder. As a result, the printing sheet can be padded. Hence, a photosensitive printing plate having a thickness of about 3 mm can be readily used on a printing machine set for use with a photosensitive printing plate having a thickness of about 7 mm, by means of setting the flexographic printing pad to a predetermined thickness. Further, the flexographic printing pad of the invention can be readily removed from the cylinder. Hence, the printing machine enables easy combined use of a photosensitive printing plate having a thickness of about 7 mm and that having a thickness of about 3 mm. The flexographic printing pad and the printing sheet are gradually wrapped around the cylinder. Hence, air trapped between the flexographic printing pad and the cylinder and air trapped between the flexographic printing pad and the printing sheet are gradually squeezed out. Hence, deterioration of a printing characteristic due to application of an uneven pressure, which would otherwise be caused by residual air, is prevented. Therefore, a high printing characteristic can be ensured.

Second, the first configuration is further characterized in that the magnet section and the cushion section are arranged side by side in the same plane.

Third, the first or second configuration is further characterized in that the magnet section and the cushion section are arranged adjacent to each other.

Fourth, any one of the first through third configurations is further characterized in that the magnet section and the cushion section possess a pliable characteristic. As a result, the flexographic printing pad can be fixed to the cylinder tightly.

Fifth, any one of the first through fourth configurations is characterized by further comprising a sheet-like section for covering an upper surface of the magnet section and that of the cushion section. The flexographic printing pad is attached to the cylinder such that the surface of the pad on which the magnet section is provided faces the cylinder. As a result, since the sheet-like section is provided on the surface of the flexographic printing pad with which the printing sheet having a photosensitive printing plate is brought into contact, the chance of printing ink or the like adhering to the cushion section can be reduced.

Sixth, there is provided a flexographic printing pad to be used as a member for raising a photosensitive printing plate during flexographic printing, the pad comprising: a sheet-like section formed from a sheet-like member; a magnet section fixed to one surface of the sheet-like member; and a sheet-like cushion section fixed to the surface of the sheet-like section so as to be adjacent to the magnet section.

By means of the sixth configuration, when a printing sheet (also called a “printing plate”) having a photosensitive printing plate is wrapped around a cylinder, the printing sheet is wrapped over the flexographic printing pad while the magnet section is attached to the cylinder. As a result, the printing sheet can be raised. Hence, a photosensitive printing plate having a thickness of about 3 mm can be readily used on a printing machine set for use with a photosensitive printing plate having a thickness of about 7 mm, by means of setting the flexographic printing pad to a predetermined thickness. Further, the flexographic printing pad of the invention can be readily removed from the cylinder. Hence, the printing machine enables easy combined use of a photosensitive printing plate having a thickness of about 7 mm and that having a thickness of about 3 mm. The flexographic printing pad is provided with the sheet-like section. Hence, as a result of the pad being attached to the cylinder while the surface of the pad on which the magnet section is provided faces the cylinder, the sheet-like section provided on the surface with which the printing sheet is brought into contact can reduce the chance of printing ink or the like adhering to the cushion section. The flexographic printing pad and the printing sheet are gradually wrapped around the cylinder. Hence, air trapped between the flexographic printing pad and the cylinder and air trapped between the flexographic printing pad and the printing sheet are gradually squeezed. Hence, deterioration of a printing characteristic due to application of an uneven pressure, which would otherwise be caused by residual air, is prevented. Therefore, a high printing characteristic can be ensured.

Seventh, the fifth or sixth configuration is further characterized in that the sheet-like section is formed from a film member.

Eighth, the sixth or seventh configuration is further characterized in that the cushion section and the sheet-like section possess a pliable characteristic. Ninth, any one of the sixth through eight configurations is further characterized in that the magnet section possesses a pliable characteristic. According to the eighth and ninth configurations, the flexographic printing pad can be fixed to the cylinder tightly.

Tenth, any one of the first through ninth configurations is further characterized in that the cushion section is formed from open-cell foam. As a result, the chance of air remaining between the cushion section and the cylinder is eliminated, and the air does not remain in the cushion section. Accordingly, uniform pressure can be obtained, thus achieving superior print quality.

Eleventh, anyone of the first through tenth configurations is further characterized in that the magnet section is substantially identical in thickness with the cushion section. Alternatively, the magnet section may be made identical in thickness with the cushion section.

Twelfth, any one of the first through tenth configurations is further characterized in that the magnet section is formed more thinly than the cushion section.

Thirteenth, any one of the first through twelfth configurations is further characterized in that the thickness of the entire flexographic printing pad assumes a value falling within the range of 3.5 mm to 4.5 mm. Fourteenth, any one of the first through twelfth configurations is further characterized in that the thickness of the entire flexographic printing pad assumes a value of 4 mm. In particular, the thickness of the entire flexographic printing pad is set to 4 mm, so that the flexographic printing pad can be preferably used for raising a photosensitive printing plate having a thickness of about 3 mm.

Fifteenth, there is provided a method for wrapping a photosensitive printing plate (particularly, a printing sheet having a photosensitive printing plate) around a cylinder during flexographic printing (may also be called a “printing sheet wrapping method”), the method comprising the steps of attaching a flexographic printing pad having any one of the first through fourteenth configurations to a cylinder by causing a magnet section in the flexographic printing pad to adhere to the cylinder, and wrapping the flexographic printing pad to the cylinder by way of a printing sheet, by means of placing the printing sheet having a photosensitive printing plate onto the flexographic printing pad attached to the cylinder. A magnet section of the flexographic printing member having any one of the first through fourteenth configurations is caused to adhere to the cylinder, thereby attaching the flexographic printing pad to the cylinder. As a result, the photosensitive printing plate is raised.

Since the photographic printing plate can be raised, a photosensitive printing plate having a thickness of about 3 mm can be readily used on the printing machine set for use with a photosensitive printing plate having a thickness of about 7 mm, by means of setting the thickness of the flexographic printing pad to a predetermined value. Further, the flexographic printing pad of the invention can be readily removed from the cylinder, and hence a printing machine can readily use a photosensitive printing plate having a thickness of about 7 mm in conjunction with that having a thickness of about 3 mm.

### BRIEF DESCRIPTION OF THE DRAWINGS

FIG. 1 is a view showing the configuration of a base sheet according to an embodiment of the invention, particularly, (a) is a cross-sectional view of the principal section of the base sheet and (b) is a plan view of the principal section;

FIG. 2 is a perspective view showing the base sheet of the embodiment of the invention;

FIG. 3 is a descriptive view showing a curved state of the base sheet;

FIG. 4 is a view showing a printing sheet, particularly, (a) is a cross-sectional view of the principal section of the printing sheet and (b) is a plan view of the principal section;

FIG. 5 is a perspective view showing the printing sheet;

FIG. 6 is a perspective view showing the construction of a flexographic printing rotary press;

FIG. 7 is a descriptive view showing a state of a printing cylinder when the base sheet and the printing sheet are wrapped around the cylinder;

FIG. 8 is a descriptive view showing a state of a printing cylinder when the base sheet and the printing sheet are wrapped around the cylinder;

FIG. 9 is a descriptive view showing a state of a printing cylinder when the base sheet and the printing sheet are wrapped around the cylinder;

FIG. 10 is a descriptive view showing a state of a printing cylinder when the base sheet and the printing sheet have been wrapped around the cylinder;

FIG. 11 is a cross-sectional view showing the printing sheet and the base sheet when they remain in close contact with each other; and

FIG. 12 is a descriptive view showing the photosensitive printing plate adhering to the printing cylinder.

### BEST MODE FOR IMPLEMENTING THE INVENTION

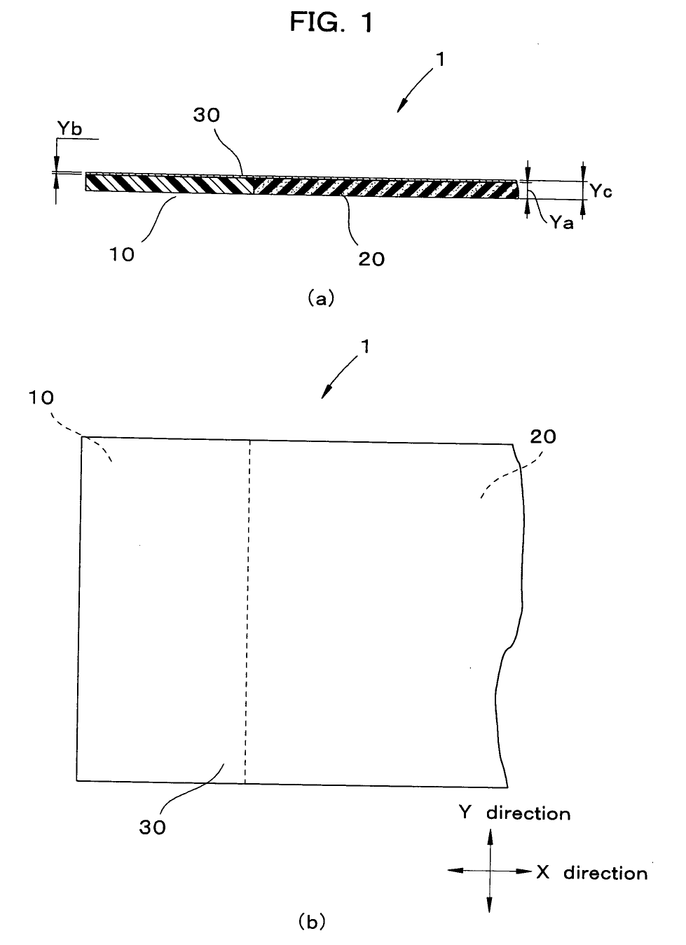

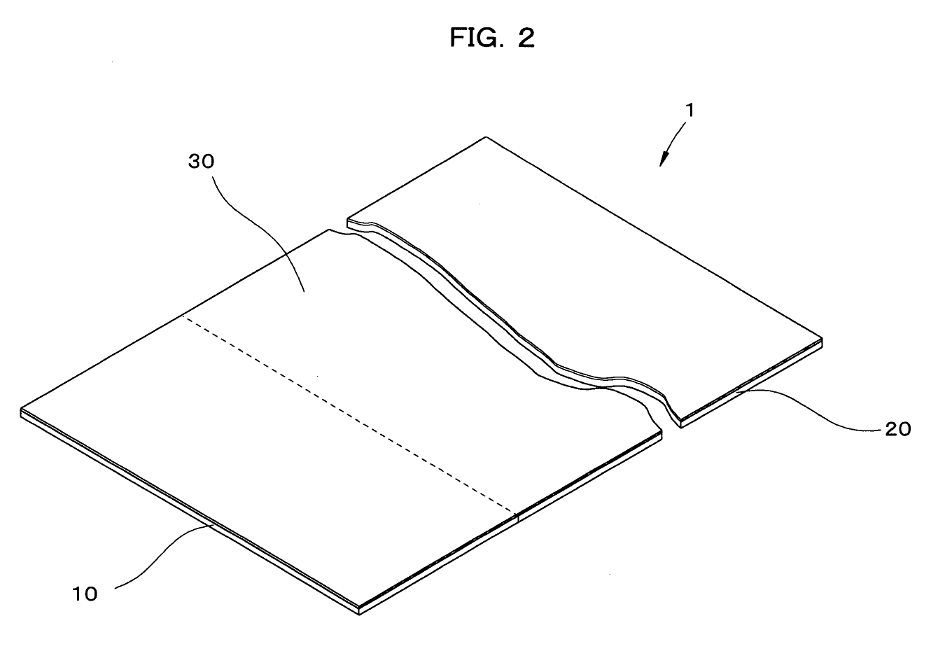

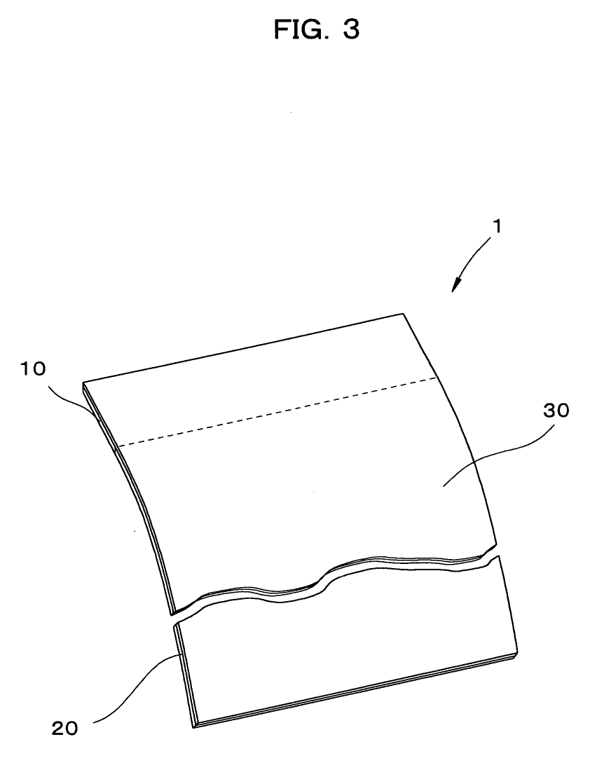

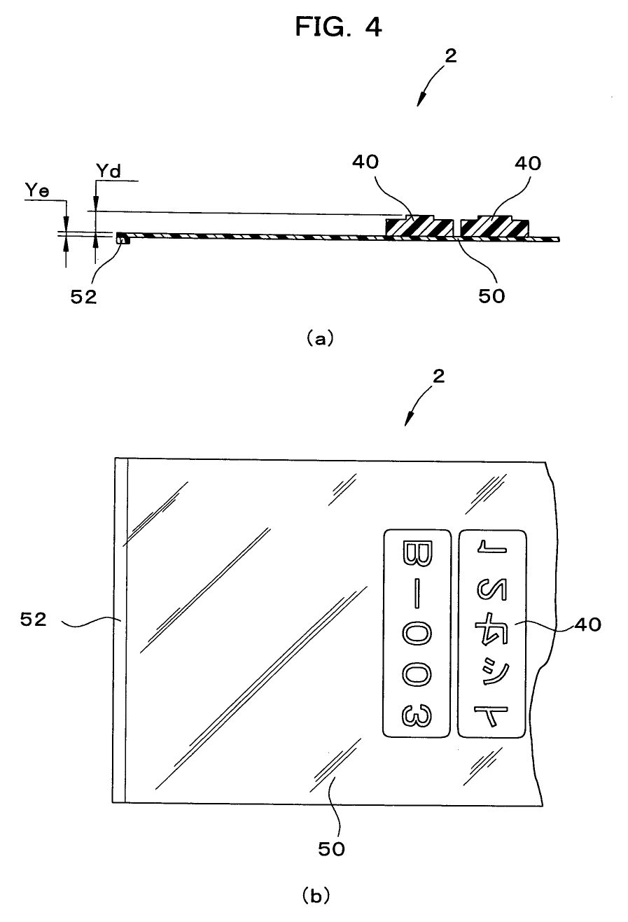

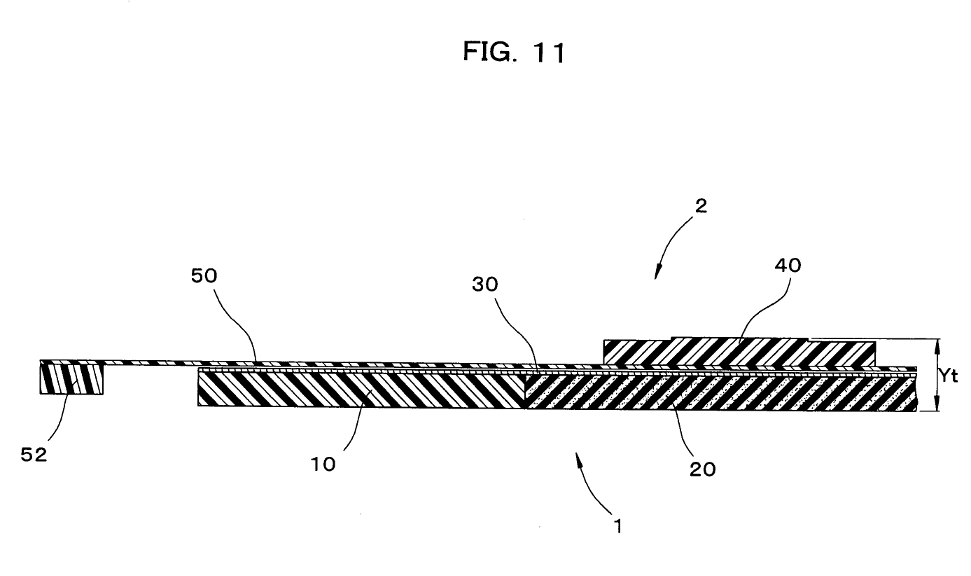

An embodiment of the invention will be described by utilization of drawings. As shown in FIG. 1(a), (b), FIG. 2, and FIG. 3, a base sheet 1 serving as a flexographic printing pad of the invention includes a magnet section 10, a cushion section 20, and a polyester film (sheet-like section) 30. As will be described later, the base sheet 1 acts as base material when a printing sheet 2 is wrapped around a printing cylinder R10 of a rotary press R1. Here, the cross-sectional view is drawn while emphasis is placed on a portion of thicknesswise direction. For instance, FIG. 1(a), FIG. 4, and FIG. 11 are drawn while a slight emphasis is placed on a thicknesswise direction for making the drawings easy to understand. Further, the base sheet 1 is formed long in a longitudinal direction (i.e., the X direction of FIG. 1(b)), and hence portions of FIG. 2 and FIG. 3 are drawn in the form of broken views.

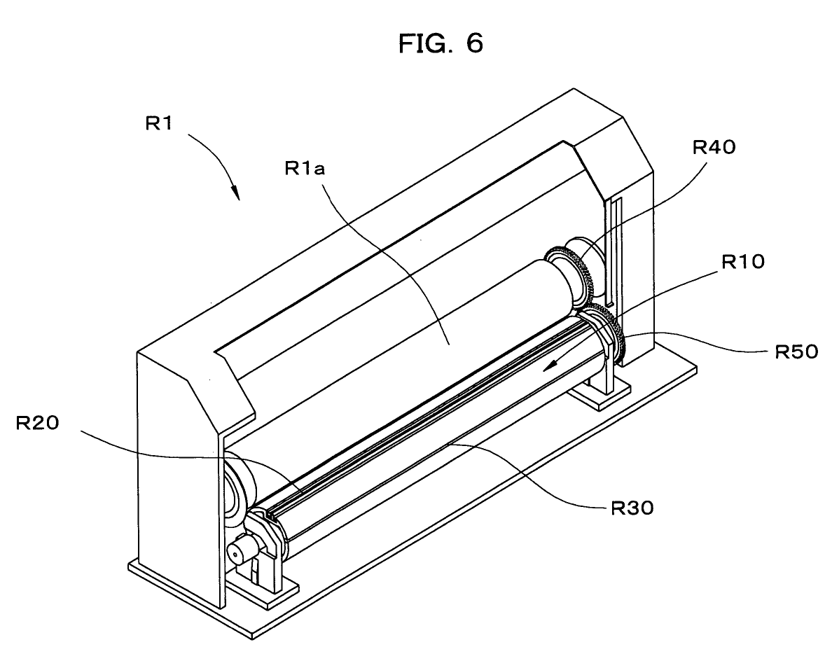

The magnet section 10 is formed from a sheet-like magnet; that is, a polyvinyl chloride magnet sheet which includes a magnetic powder exhibiting magnetic properties. The magnetic section possesses pliable and flexible characteristics. Therefore, the magnet section 10 can be readily wrapped around the surface of the cylindrical printing cylinder R10 (see FIG. 6). The magnet section has a predetermined width and a predetermined length and is formed into a substantially rectangular-parallelepiped sheet. Specifically, the magnet section 10 assumes a rectangular shape when viewed from the top. The thickness of the magnet section 10 will be described later.

The cushion section 20 assumes a sheet-like shape and possesses pliable and flexible characteristics. The cushion section assumes a width substantially identical with that of the magnetic section 10 (preferably the same width as that of the magnetic section) and a predetermined length and is formed into the shape of a substantially rectangular-parallelepiped sheet. The cushion section 20 assumes a rectangular shape when viewed from the top. Specifically, the length of the cushion section 20; that is, the length of the cushion section in the X direction of FIG. 1(b), is greater than that of the magnet section 10. The thickness Ya of the cushion section 20 (see FIG. 1) is substantially identical with that of the magnet section 10 (preferably the same as that of the magnet section); that is, a value of about 3.812 mm (preferably, a value of precisely 3.812 mm). In reality, the magnet section 10 is made slightly thinner than the cushion section 20, in consideration that the thickness of the cushion section 20 becomes slightly smaller when in use. Specifically, when material to be printed passes through a space defined between the printing cylinder and the pressure cylinder during printing, the cushion section 20 becomes slightly dented. The extent to which the cushion section 20 is dented is usually greater than that to which the magnet section 10 becomes dented. Therefore, the thickness of the magnet section 10 is made slightly smaller than that of the cushion section 20. When the thickness Ya of the cushion section 20 is set to a value of 3.812 mm, the thickness of the magnet section 10 is made slightly smaller than a value of 3.812 mm. A difference between the thickness of the cushion section and that of the magnet section is on the order of one-hundredth of a millimeter. For instance, as will be described later, when the thickness of the printing sheet 2; that is, a total thickness of a photosensitive printing plate 40 and a film member 50 is set to 3.028 mm, a total thickness of the printing sheet 2 and the base sheet 1 exceeds 7 mm. Hence, setting only the thickness of the magnet section 10 to 3.784 mm (=3.812-0.028) such that a thickness of precisely 7 mm is achieved at the magnet section 10 is conceivable. Concurrently, setting the thickness of the cushion section 20 to 3.784 mm in agreement with the setting the thickness of the magnet section 10 to 3.784 mm is also conceivable.

When the thickness of the cushion section 20 is set to about 3.812 mm, the thickness of the magnet section 10 may be made equal to that of the cushion section 20; that is, about 3.812 mm (preferably a value of precisely 3.812 mm).

The cushion section 20 is a sponge made of material such as rubber or urethane foam. The cushion section 20 is made of open-cell foam material; that is, an open-cell foam. Specifically, the cushion material 20 is formed from material in which air bubbles are spread over the entirety of material and are continuous with each other. Since the cushion section 20 is formed from an open-cell foam, air can be discharged well. Further, the cushion section has a small residual compressive strain and is superior in dimensional stability. The cushion section 20 is arranged such that side edges of the cushion section 20 remain in contact with side edges of the magnet section 10.

The polyester film 30 assumes the shape of a sheet and is formed from polyester material. The polyester film 30 is formed to an outer dimension substantially identical with that of a surface geometry formed when the magnet section 10 and the cushion section 20 are placed side by side. The thickness Yb of the polyester film 30 is set to about 0.188 mm (preferably a value of precisely 0.188 mm). The polyester film 30 is formed from a sheet-like member and assumes a square shape (specifically, a rectangular shape) when viewed from the top. A film formed from another material may also be used in place of the polyester film 30. In addition, another sheet-like member may also be employed.

As shown in FIG. 1(a), the magnet section 10 and the cushion section 20, which are formed in the manner as mentioned above, are arranged side by side. The polyester film 30 is placed so as to cover the magnet section and the cushion section while an adhesive is applied over the entire film, thereby integrating them into the base sheet 1. The magnet section 10 and the polyester film 30 are bonded together with the adhesive applied over the entirety of the film. Further, the cushion section 20 and the polyester film 30 are also bonded together by means of the adhesive applied over the entire surface of the film.

The magnet section 10, the cushion section 20, and the polyester film 30 assume the previously-described thicknesses. Hence, the total thickness Yc of the base sheet 1 (see FIG. 1) assumes a value of 4.000 (=3.812+0.188) mm. In particular, a total thickness consisting of the thickness of the cushion section 20 and that of the polyester film 30 assumes 4.000 mm. The reason why the total thickness Yc of the base sheet 1 is set to 4.000 mm is that the printing sheet 2 (which will be described later) with a photosensitive printing plate 40 of about 3 mm thickness can be set on a rotary press of the printing machine set for use with a photosensitive printing plate having a thickness of about 7 mm.

The base sheet 1 assumes an overall sheet-like shape and a substantially square shape (specifically, a rectangular shape) when viewed from the top. The length of the base sheet 1 in the direction in which the sheet is to be wrapped (i.e., the x direction of FIG. 1(b)) is determined by the size of a printing cylinder to be used. Further, the length of the base sheet in the direction perpendicular to that in which the sheet is to be wrapped (i.e., the Y direction of FIG. 1(b)) is determined by the size of the printing sheet 2 to be used.

In the thus-formed base sheet 1, the magnet section 10, the cushion section 20, and the polyester film 30 each possess the pliable and flexible characteristics. Therefore, as shown in FIG. 3, the base sheet is freely curved and bent and possesses sufficient pliable and flexible characteristics. At least, the base sheet 1 has a pliable characteristic which enables bending of the sheet in other directions as well as in the X direction shown in FIG. 1(b). Therefore, as will be described later, the base sheet 1 can be readily wrapped around the surface of the cylindrical printing cylinder in a rotary press. In order to enable wrapping of the base sheet around the cylindrical printing cylinder, the base sheet 1 must be curved in at least the X direction of FIG. 1(b).

There will now be described the printing sheet 2 (also called a printing plate). As shown in FIGS. 4(a), (b), the printing sheet 2 has the photosensitive printing plate 40, a film member 50, and a pair of bars 52. The printing sheet 2 is equipped with a so-called photosensitive printing plate having a thickness of about 3 mm.

Here, the photosensitive printing plate 40 is formed from so-called Elaslon resin (the trade name: manufactured by Tokyo Ohka Kogyo Co., Ltd.) which is photosensitive resin. Through a printing plate preparation process similar to a related-art printing plate preparation process, the resin is exposed through a certain required mask. Most of the unexposed portions are subjected to a cutting out process, a development process, a drying process, and a post-treatment process, thereby forming a printing plate having a relief surface of predetermined geometry and possessing pliable and flexible characteristics. The thickness Yd of the photosensitive printing plate 40 (see FIG. 4) is set to 2.84 mm. In other words, this photosensitive printing plate is a photosensitive printing plate having a thickness of about 3 mm.

The film member 50 assumes the form of a transparent sheet and is formed from polyester material into a square shape when viewed from the top. The film member 50 is formed to such a size as to be able to cover the entire base sheet 1. The film member 50 is formed such that the width and length of the film member become slightly larger than those of the base sheet 1. The thickness Ye of the film member 50 is set to 0.188 mm. As a result, a total thickness consisting of the thickness of the photosensitive printing plate 40 and that of the film member 50 is set to 3.028 (=2.840+0.188) mm. Here, the film member 50 may be non-transparent.

The bars 52 are formed in rods having a square cross-sectional profile. The length of the bars 52 is substantially identical with the width of the film member 50 in the direction perpendicular to that in which film member is to be wrapped. The bars 52 are attached, with an adhesive, to side edges of the film member 50 in the direction in which the film member is to be wrapped around a printing cylinder to be described later. The bars 52 are preferably formed from lightweight resin and so on.

One or a plurality of photosensitive printing plates 40, each having a predetermined relief image formed on its surface, are provided on the surface of the film member 50. The film member 50 and the photosensitive printing plate 40 are bonded together by means of an unillustrated double-sided tape and an unillustrated adhesive, thereby forming the printing sheet 2.

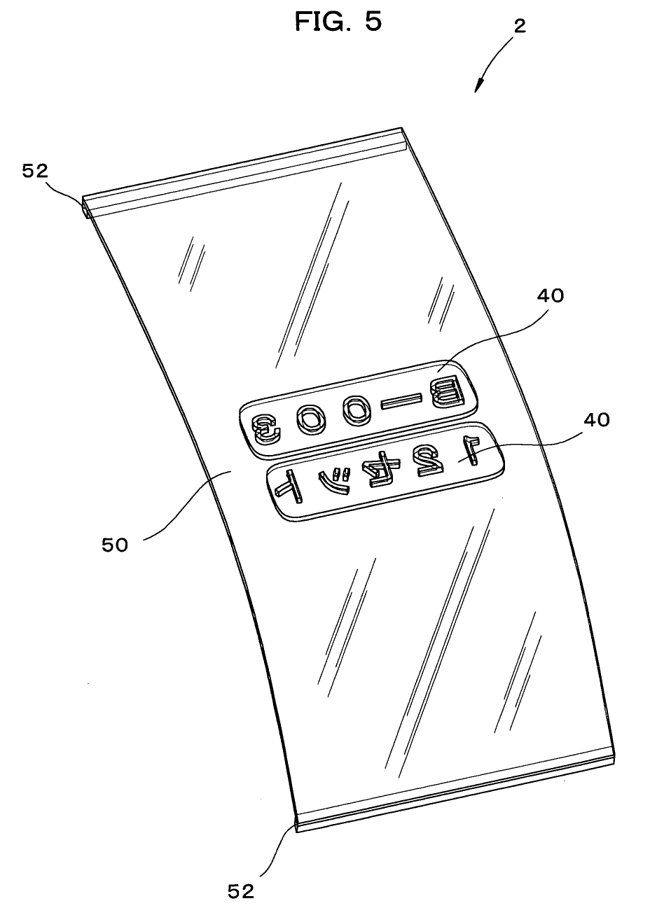

Since the photosensitive printing plate 40 and the film member 50 possess pliable and flexible characteristics as shown in FIG. 5, the thus-formed printing sheet 2 is freely curved and bent and possesses sufficient pliable and flexible characteristics. Therefore, as will be described later, the printing sheet can be readily wrapped around the surface of a cylindrical printing cylinder located in a rotary press.

Next, the service condition of the photosensitive printing sheet of the embodiment will be described. The base sheet 1 of the embodiment is used as a base when a photosensitive printing plate is wrapped around a printing cylinder during flexographic printing. In other words, the base sheet is used as a member for raising a photosensitive printing plate.

FIG. 6 is a perspective view showing the rotary press R1 of a printing machine to be employed in the embodiment. The rotary press R1 has a printing cylinder (a plate drum) R10 and a pressure cylinder (press drum) R1a. The printing cylinder R10 assumes a substantially cylindrical shape. A nip shaft R20 and a plurality of catch grooves R30 are formed in a chromium-plated outer circumferential surface of the printing cylinder in the direction perpendicular to the axis of the printing cylinder R10.

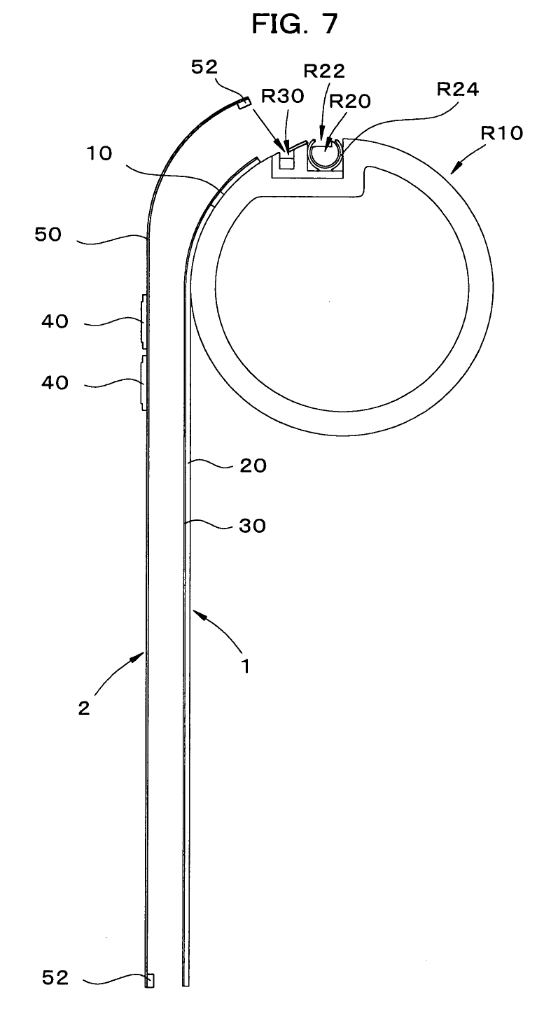

As shown in FIGS. 6 and 7, the nip shaft R20 is formed into a round rod. A catch groove R22 is formed in and across the overall length of the nip shaft R20. The nip shaft is rotatably inserted into a guide stay R24 placed in a groove formed in the printing cylinder R10 in the direction perpendicular to the axis thereof. An unillustrated ratchet mechanism is engaged with the nip shaft R20. When the ratchet mechanism is in operation, forward rotation (e.g., leftward rotation) of the nip shaft 20 is allowed, but reverse rotation (e.g., rightward rotation) of the same is locked. When the ratchet mechanism is released, rotation of the nip shaft R20 becomes free.

The bars 52 of the printing sheet 2 are fitted into the catch grooves R30, thereby enabling catching of the bars 52. Thus, the printing sheet 2 is wrapped around the outer circumferential surface of the printing cylinder R10 through use of the nip shaft R20 and the plurality of catching grooves R30.

A specific method for attaching the base sheet 1 and the printing sheet 2 together will now be described. As shown in FIG. 7, the magnet section 10 of the base sheet 1 will be attached to the outer circumferential surface of the printing cylinder R10 while being aligned to the direction perpendicular to the axis of the printing cylinder R10, by means of magnetic force of the magnet section 10. A position to which the magnet section 10 is to be attached is preferably separated slightly from the catch groove R30. This operation corresponds to the mounting process.

As shown in FIG. 7, the bar 52 provided on one side of the printing sheet 2 to which the photosensitive printing plate 40 is attached is fitted and latched into the catch groove R30 formed at the predetermined location. In this state, as shown in FIG. 7, the base sheet 1 and the printing sheet 2 remain hanging down.

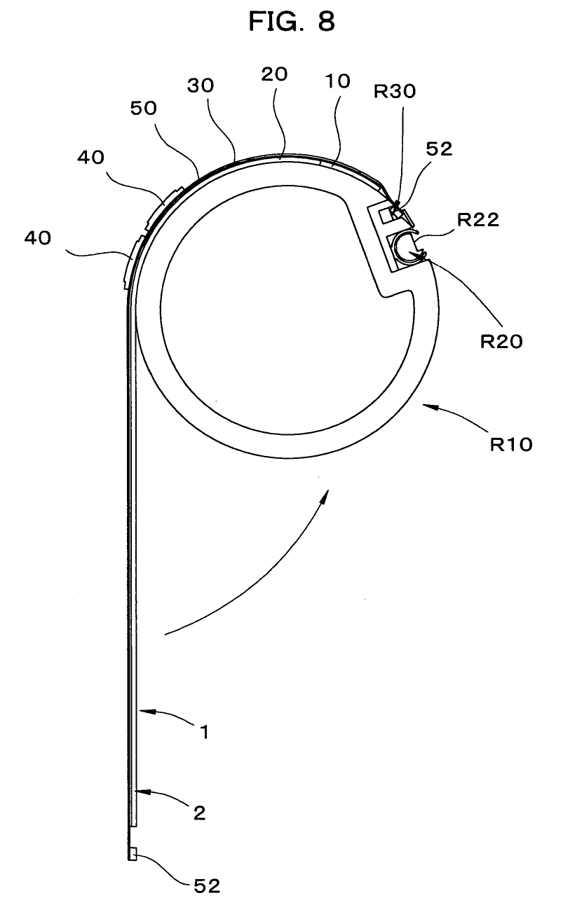

As shown in FIG. 8, the base sheet 1 and the printing sheet 2 are gradually wrapped around the printing cylinder (cylinder) R10. Specifically, the printing sheet 2 is wrapped around the base sheet 1. This operation corresponds to the wrapping process.

Then, the air trapped between the base sheet 1 and the printing cylinder R10 and the air trapped between the base sheet 1 and the printing sheet 2 are gradually squeezed out. Hence, air does not remain in these spaces. Particularly, since the cushion section 20 is formed from the previously-described urethane foam, the base sheet 1 is gradually wrapped around the printing cylinder R10, thereby squeezing the air trapped between the cushion section 20 and the printing cylinder R10. Further, the air trapped in the cushion section 20 is discharged, thereby preferably discharging the air. As a result, air will not enter a lower portion of the photosensitive printing plate 40, thereby preventing the photosensitive printing plate 40 from being subjected to unevenness in printing pressure during printing. The material of the cushion section 20 is urethane foam, and hence compressive residual strain becomes small, and superior dimensional stability is achieved. Consequently, a high-level printing characteristic can be ensured.

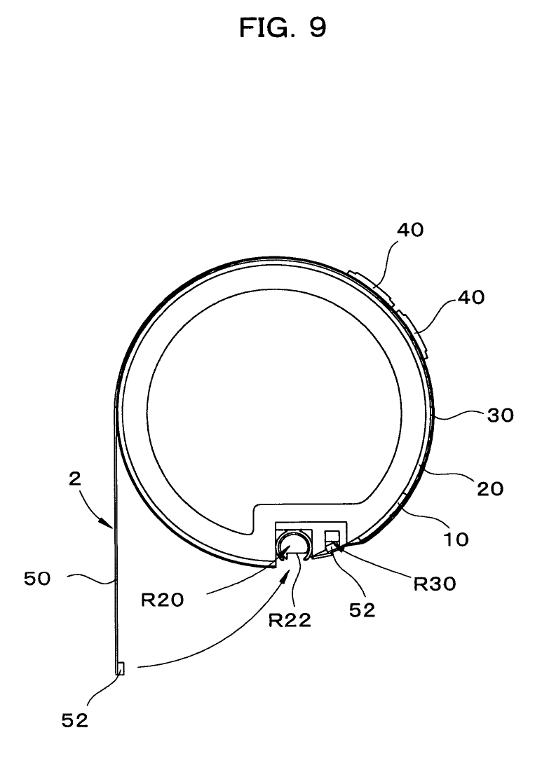

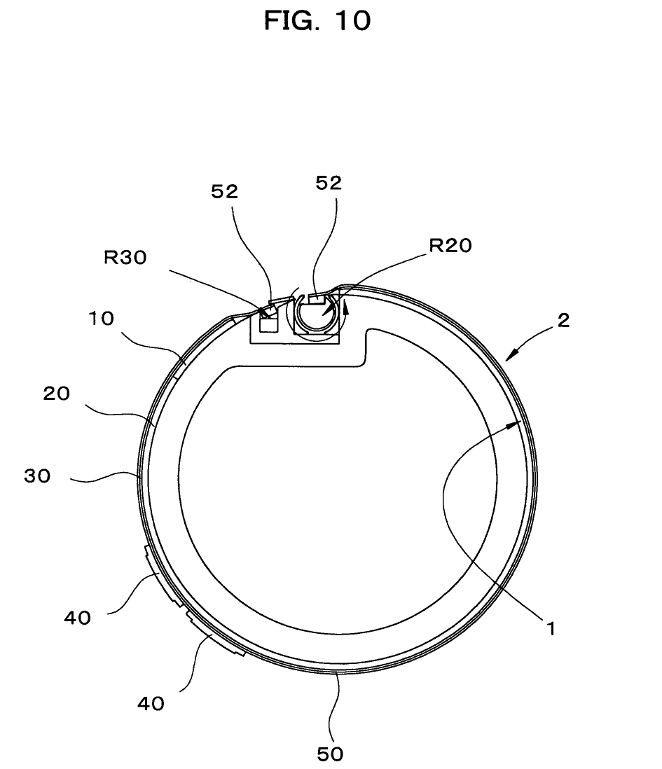

As shown in FIG. 8, the base sheet 1 and the printing sheet 2 are wrapped around the printing cylinder R10. As shown in FIG. 9, the bar 52 provided at the other end is fitted into the catch groove R22 of the nip shaft R20. In this state, the nip shaft R20 is rotated forward (e.g., a rightward direction) by means of a spanner such as that shown in FIG. 10. The bar 52 is entangled in the nip shaft R20, thereby tightly drawing the base sheet 1. Therefore, the base sheet 1 and the printing sheet 2 are tightly affixed to the outer circumferential surface of the printing cylinder R10 without involvement of clearance or strain.

In this case, as shown in FIG. 11, a total thickness Yt (see FIG. 11) consisting of the thickness of the base sheet 1 and that of the printing sheet 2 at the position where the photosensitive printing plate 40 is provided is determined as a total of the thickness Yc (4 mm) of the base sheet 1, the thickness Yd (2.840 mm) of the photosensitive printing plate 40, and the thickness Ye (0.188 mm) of the film member 50. Accordingly, a total thickness Yt consisting of the thickness of the base sheet 1 and that of the printing sheet 2 at the location where the photosensitive printing sheet 40 is provided assumes a value of 7.028 mm.

The pressure cylinder R1a is formed into a substantially cylindrical shape whose outer dimension is substantially identical with that of the printing cylinder R10. An outer circumferential surface of the pressure cylinder is plated with chromium. The pressure cylinder R1a is placed at a position above and substantially in parallel with the printing cylinder R10 so that a gap between the pressure cylinder R1a and the printing cylinder R10 can be adjusted. In this case, the gap between the pressure cylinder R1a and the printing cylinder R10 is set so as to be compatible with a photosensitive printing plate having a thickness of about 7 mm. Specifically, the gap is set to a value determined by adding the thickness of a printed matter to a thickness of 7 mm.

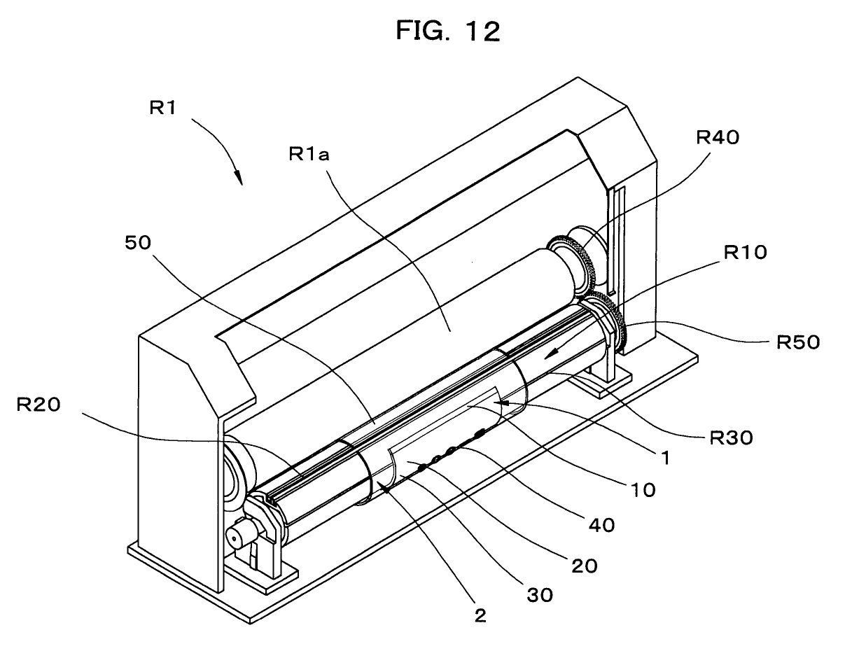

The pressure cylinder R1a and the printing cylinder R10 are rotatively driven at a predetermined speed by means of an unillustrated drive device. In this case, as shown in FIG. 12, a bevel gear R40 and a bevel gear R50 mesh with each other, thereby transmitting rotation to the pressure cylinder R1a and the printing cylinder R10. The pressure cylinder R1a and the printing cylinder R10 are rotated in reverse at all times.

The diameter of the printing cylinder R10 and that of the pressure cylinder R1a are set such that the diameter of the printing cylinder R10 plus that the thickness of the photosensitive printing plate when the photosensitive printing plate of about 7 mm thickness is wrapped around the printing cylinder R10 becomes equal to the diameter of the pressure cylinder R1a. Hence, as a result of the photosensitive printing plate having a thickness of about 3 mm being raised by the base sheet 1, the diameter of the printing cylinder R10 consisting of the thickness of the base sheet 1 and an about 3 mm thickness of the photosensitive printing plate becomes equal to the diameter of the pressure cylinder R1a, thereby enabling smooth rotation.

Therefore, a matter to be printed, such as a corrugated board, is inserted into a space defined between the pressure cylinder R1a and the printing cylinder R10, thereby drawing the matter. The surface of the photosensitive printing plate 40 of the printing cylinder R10 and the surface of the matter to be printed are brought into pressed contact, whereby quick-drying ink is transferred onto a matter to be printed from the photosensitive printing plate 40. As a result, the matter to be printed is printed.

In this case, a total thickness Yt consisting of the thickness of the base sheet 1 and that of the printing sheet 2, both being obtained at the location where the photosensitive printing plate 40 is placed, is 7.028 mm. The total thickness is slightly greater than an ordinary thickness of the photosensitive printing sheet; that is, about 7 mm. In consideration of the fact that the thickness of the cushion section 20 becomes slightly smaller as the base sheet 1 is used, such a thickness can be said to be appropriate.

As mentioned above, in relation to the base sheet 1 of the embodiment, the magnet section 10 and the cushion section 20 are formed side by side in the same plane. Hence, the base sheet 1 can be readily attached to the printing cylinder R10 by means of the magnet section 10. The photosensitive printing plate having a thickness of about 3 mm can be readily used for a rotary press R1 set for use with a photosensitive printing plate having a thickness of about 7 mm. When a photosensitive printing plate having a thickness of about 7 mm is used after use of the photosensitive printing plate having a thickness of about 3 mm, the base sheet 1 that is caused to adhere to the printing cylinder with the magnet section 10 is removed from the printing cylinder R10. Hence, combined use of a photosensitive printing plate having a thickness of about 7 mm and a photosensitive printing plate having a thickness of about 3 mm becomes easy. The base sheet 1 is formed to a thickness of about 4 mm. Hence, even in the case of a photosensitive printing plate having a thickness of about 3 mm, the plate can be applied to a printing machine set for use with a photosensitive printing plate having a thickness of about 7 mm by means of raising the printing plate. In particular, even in the event that a photosensitive printing plate using aqueous solution becomes pervasive in future, the printing machine will be able to cope with the photosensitive printing plate by raising the printing plate through use of the base sheet 1 of the embodiment.

In particular, when a photosensitive printing plate having a thickness of about 3 mm is used, an attempt can be made to achieve weight reduction. Ease of operation can be improved by weight reduction. A degree of practical weight reduction is about one-half of the weight of a photosensitive printing plate having a thickness of about 7 mm. Further, the photosensitive printing plate having a thickness of about 3 mm is thinner than a photosensitive printing plate having a thickness of about 7 mm and hence less susceptible to damage. Further, a smaller volume of resin is required to form such a photosensitive printing plate, thus achieving resource savings. The amount of industrial waste can be reduced at the time of disposal of printing plates. Use of the photosensitive printing plate having a thickness of about 3 mm is more effective than use of a photosensitive printing plate having a thickness of about 7 mm.

As mentioned above, the cushion section 20 is formed from open-cell foam. The base sheet 1 is gradually wrapped around the printing cylinder R10, thereby lessening a chance of air remaining between the cushion section 20 and the printing cylinder R10. Since the cushion section 20 is formed from open-cell foam, no air remains in the cushion section 20. Therefore, application of an uneven pressure and deterioration of a printing characteristic, such as the impossibility of printing small characters, which would otherwise arise during printing, is prevented. Therefore, a high printing characteristic can be ensured.

The polyester film 30 is provided on the base sheet 1 of the embodiment. Therefore, staining of the cushion section 20, which would otherwise be caused by ink, can in particular be prevented. More specifically, the polyester film 30 is provided over the entire surface of plane surface the base sheet 1. When the base sheet 1 is caused to adhere to the printing cylinder R10, the cushion section 20 faces the printing cylinder R10. Hence, the cushion section 20 is covered with the polyester film 30. Even when printing ink falls to the base sheet 1, the polyester film 30 protects the cushion section 20 and the magnet section 10 from stains, which would otherwise be caused by the ink.

The photosensitive printing plate 40 is formed from Elaslon resin and the cushion section 20 is formed from urethane foam. Hence, high elastic force stemming from a double elastic material can be achieved. Accordingly, an advanced printing characteristic is achieved. Even when high printing accuracy is required as in the case of a graphical pattern, faithful printing can be effected.

The invention is not limited solely to the configuration described in connection with the embodiment and susceptible to various modes. For instance, the materials and sizes of individual members are selected appropriately in accordance with features of a printed matter or the type of ink.

Although in the foregoing descriptions the thickness of the entire base sheet 1 has been described to be 4 mm, the thickness may assume a value of 3.5 to 4.0 mm.

### INDUSTRIAL APPLICABILITY

As has been described, a flexographic printing pad according to the invention enables raising of a printing sheet having a photosensitive printing plate. Hence, a photosensitive printing plate having a thickness of about 3 mm can be readily used in a printing machine set for use with a photosensitive printing plate having a thickness of about 7 mm by setting the flexographic printing pad to a predetermined thickness (particularly, a thickness of 4 mm). Since the flexographic printing pad of the invention can be readily removed from a cylinder, the printing machine readily enables combined use of a photosensitive printing plate having a thickness of about 7 mm and that having a thickness of about 3 mm. A cushion section and the printing sheet are gradually wrapped around the cylinder. Hence, air trapped between the flexographic printing pad and the cylinder and air trapped between the flexographic printing pad and the printing sheet are gradually squeezed out. Hence, deterioration of a printing characteristic due to application of an uneven pressure, which would otherwise be caused by residual air, is prevented. Therefore, a high printing characteristic can be ensured.

In particular, when the pad has a sheet-like section, the chance of printing ink or the like adhering to the cushion section can be reduced, thereby preventing occurrence of a stain.

A method for wrapping a photosensitive printing plate according to the invention enables raising of a photosensitive printing plate. Hence, as a result of a flexographic printing pad being set to a predetermined thickness, a photosensitive printing plate having a thickness of about 3 mm can be readily used in a printing machine set for use with a photosensitive printing plate having a thickness of about 7 mm. A flexographic printing pad of the invention can be readily removed from a cylinder, and hence the printing machine readily enables combined use of a photosensitive printing plate having a thickness of about 7 mm and that having a thickness of about 3 mm.

1. A flexographic printing pad used as a member for raising a photosensitive printing plate during flexographic printing, the pad comprising:
a magnet section; and
a cushion section assuming a sheet-like shape.

2. The flexographic printing pad according to claim 1, wherein the magnet section and the cushion section are arranged side by side in the same plane.

3. The flexographic printing pad according to claim 1 or 2, wherein the magnet section and the cushion section are arranged adjacent to each other.

4. The flexographic printing pad according to claim 1, 2, or 3, wherein the magnet section and the cushion section possess a pliable characteristic.

5. The flexographic printing pad according to claim 1, 2, 3, or 4, further comprising a sheet-like section for covering an upper surface of the magnet section and that of the cushion section.

6. A flexographic printing pad to be used as a member for raising a photosensitive printing plate during flexographic printing, the pad comprising:
a sheet-like section formed from a sheet-like member;
a magnet section fixed to one surface of the sheet-like member; and
a sheet-like cushion section fixed to the surface of the sheet-like section so as to be adjacent to the magnet section.

7. The flexographic printing pad according to claim 5 or 6, wherein the sheet-like section is formed from a film member.

8. The flexographic printing pad according to claim 6 or 7, wherein the cushion section and the sheet-like section possess a pliable characteristic.

9. The flexographic printing pad according to claim 6, 7, or 8, wherein the magnet section possesses a pliable characteristic.

10. The flexographic printing pad according to claim 1, 2, 3, 4, 5, 6, 7, 8, or 9, wherein the cushion section is formed from open-cell foam.

11. The flexographic printing pad according to claim 1, 2, 3, 4, 5, 6, 7, 8, 9, or 10, wherein the magnet section is substantially identical in thickness with the cushion section.

12. The flexographic printing pad according to claim 1, 2, 3, 4, 5, 6, 7, 8, 9, or 10, wherein the magnet section is formed more thinly than the cushion section.

13. The flexographic printing pad according to claim 1, 2, 3, 4, 5, 6, 7, 8, 9, 10, 11, or 12, wherein the thickness of the entire flexographic printing pad assumes a value ranging from 3.5 mm to 4.5 mm.

14. The flexographic printing pad according to claim 1, 2, 3, 4, 5, 6, 7, 8, 9, 10, 11, or 12, wherein the thickness of the entire flexographic printing pad assumes a value of 4 mm.

15. A method for wrapping a photosensitive printing plate around a cylinder during flexographic printing, the method comprising the steps of:
attaching the flexographic printing pad defined in any one of claims 1 through 14 to a cylinder by causing a magnet section in the flexographic printing pad to adhere to the cylinder; and
wrapping a printing sheet to the cylinder by way of the flexographic printing pad, by means of placing the printing sheet having a photosensitive printing plate onto the flexographic printing pad attached to the cylinder.
